(19) United States
(12) Patent Application Publication
(10) Pub. No.: US 2004/0246993 A1
(43) Pub. Date: Dec. 9, 2004

(54) Method and apparatus for transmitting and receiving multi-protocol data frames

(75) Inventor: Cheol-hong An, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/859,070

(22) Filed: Jun. 3, 2004

Related U.S. Application Data
(60) Provisional application No. 60/490,907, filed on Jul. 30, 2003.

(30) Foreign Application Priority Data
Jun. 4, 2003 (KR) 10-2003-0035992

(51) Int. Cl. H04L 12/28

(52) U.S. Cl. 370/469; 370/537

(57) ABSTRACT

The present invention relates to method and device for transmitting and receiving multi-protocol data frames. The method of the present invention includes receiving data from FCSLs supporting a variety of different protocols, transmitting the data including identifiers for identifying which FCSL sends the data, and locating a relevant FCSL based on the identifier included in the data forwarded by other devices and delivering the received data to the relevant FCSL. The device of the present invention includes at least two FCSLs, an FCSL LLC for adding identification information to allow a receiving device to identify from which FCSL the data are received, and a MAC layer for transmitting and receiving the data.

### BACKGROUND OF THE INVENTION

This application claims priority from Korean Patent Application No. 10-2003-0035992 filed on Jun. 4, 2003 in the Korean Intellectual Property Office and U.S. Provisional Patent Application No. 60/490,907 filed on Jul. 30, 2003, the disclosures of which are incorporated herein by reference.

1. Field of Invention

The present invention relates to a method and an apparatus for transmitting and receiving data frames in various protocols.

2. Description of the Related Art

With the development of digital technology, we have been able to enjoy a large number of digital products easily in our daily lives, thereby making our lives more convenient. A variety of digital products such as DVD players, cable set-top boxes (STBs), digital video cassette recorders (DVCRs), digital TV (DTV) sets and personal computers are currently available and others are under development. These digital products may be individually used or connected with one another on a single network. Such a network is called a personal area network (PAN). A related art PAN has been generally implemented as a wired network using cables. However, as wireless communication technology advances, wireless PAN is becoming increasingly common. For communications in the wireless PAN, all devices in a piconet defined by IEEE 802.15.3 can gain access to a wireless medium (WM) depending on information provided by a piconet coordinator (hereinafter, referred to as a “PNC”). This information is broadcast through a beacon. One piconet is determined according to a piconet ID (PNID) and a beacon source ID (BSID) that are defined by the PNC. To one piconet may be connected a variety of different devices employing various protocols and different transfer modes such as IEEE 1394, USB and IEEE 802 families.

FIG. 1 is a block diagram illustrating a frame convergence sub-layer model of the related art in which a variety of protocols are used.

The open systems interconnection (OSI) 7 layer model has a physical layer serving as the lowest layer and a data link layer above the physical layer. The data link layer comprises two sub-layers: a medium access control (MAC) sub-layer and a frame convergence sub-layer (FCSL). Service access points (SAPs) serving as an interface for linking the adjacent layers are present between the layers. As the interface in FIG. 1, there are a PHY SAP between the physical layer and the MAC layer and a FCSL SAP between the MAC layer and the FCSL. Also in FIG. 1, there are shown several FCSLs for use in a variety of protocols, e.g. IEEE 1394, IEEE 802.2, USB, and other protocols (hereinafter, referred to as “XXXX protocols”). Between the FCSLs for use in the respective protocols and the applications using the relevant protocols are the FCSL SAPs serving as interfaces, e.g. 1394 SAP for an IEEE 1394 application, 802.2 SAP for an IEEE 802.2 application, USB SAP for an USB application, and XXXX SAPs for other XXXX applications.

Each of the FCSLs receives packets (including a protocol data unit; hereinafter referred to as “PDU”) from an upper protocol layer through the relevant FCSL SAP, classifies the PDU according to classification rule sets, and transfers the classified PDU to the MAC SAP. Further, the FCSL receives the PDU from the MAC SAP and then transfers the received PDU to its upper layer through the relevant FCSL SAP.

As discussed above, however, there are no currently available methods for determining which sub-layer is used to transfer and receive data transferred and received through the MAC SAP when there are several FCSLs for a variety of different protocols. Therefore, it is necessary to specifically define and provide a method by which a variety of different FCSLs can be simultaneously supported.

### SUMMARY OF THE INVENTION

Accordingly, the present invention is directed to provide a FCSL logic link control serving as a service access point of data transferred or received through a MAC SAP when several FCSLs for supporting a variety of different protocols exist on a MAC layer.

According to an exemplary embodiment of the present invention for achieving the object, there is provided a method for transmitting multi-protocol data frames through a predetermined MAC, comprising: (a) receiving data frames transmitted from an upper protocol layer, (b) providing the received data frames with identification information on the upper protocol layer having transmitted the data frame, and (c) transmitting the data frames. The data frames may be transmitted in the mode of MAC based on IEEE 802.15.3. The data frames may be transferred in either mode of an asynchronous or isochronous transfer.

According to another exemplary embodiment of the present invention, there is provided a method for transmitting multi-protocol asynchronous data through a predetermined MAC, comprising: (a) receiving asynchronous data frames from an upper protocol layer, (b) providing the received asynchronous data frames with identification information on the upper protocol layer having transmitted the asynchronous data frame, and (c) transmitting the asynchronous data frames.

According to yet another exemplary embodiment of the present invention, there is provided an apparatus for transmitting multi-protocol isochronous data through a predetermined MAC, comprising: (a) receiving isochronous data frames from an upper protocol layer, (b) providing the received isochronous data frames with a stream index mapped into a frame convergence sub layer (FCSL), and (c) transmitting the isochronous data frames during a channel time allocation (CTA) of the provided stream index. A stream index mapped into an FCSL having transmitted the isochronous data may be obtained with the CTA from a piconet coordinator (PNC). The method may further comprise sending a probe response with the stream index mapping information when having received a probe request from a receiving apparatus after receipt of the CTA.

According to a further exemplary embodiment of the present invention, there is an apparatus for transmitting multi-protocol data frames, comprising a plurality of frame convergence sub-layer (FCSL) modules supporting different protocols, an FCSL logic link control (LLC) module receiving data frames from at least one module among the FCSL modules and providing the data frames to identification information so as to allow a receiving apparatus to identify the FCSL having transmitted the data frames, and a medium access control (MAC) module receiving data frames from the FCSL LLC module and transmitting the data frames to a wireless transmitting medium at an appropriate time. The MAC module may be based on IEEE 802.15.3 standards. The received data frames may comprise asynchronous data frames, and the FCSL LLC module may comprise an asynchronous service access point (SAP) attach module providing the asynchronous data frames with identification information so as to allow the receiving apparatus to identify the FCSL having transmitted the asynchronous data frames. The data frames received from the FCSL module may comprise isochronous data frames, and the FCSL LLC module may comprise a stream index storage module storing therein a stream index for the FCSL having transmitted the isochronous data frames, and the MAC module transmits the isochronous data frames during allocation of the CTA to have the stored stream index. The FCSL LLC module may further comprise a probe request/response module which responds to a probe request from the receiving apparatus, with the stream index for the FCSL having transmitted the isochronous data frames, stored in the stream index storage module.

According to another exemplary embodiment of the present invention, there is provided a method for receiving multi-protocol data frames, comprising: receiving data frames, determining an upper protocol layer to which the received data frames are transmitted, based on identification information included in the received data frames, and transmitting the received data frames to the determined upper protocol layer. The received data frames may comprise data frames in the MAC mode based on IEEE 802.15.3 standards. The received data frames may be transferred in either mode of an asynchronous or isochronous transfer.

According to yet another exemplary embodiment of the present invention, there is provided a method for receiving multi-protocol data frames, comprising the steps of receiving asynchronous data frames, determining a upper protocol layer to which the received asynchronous data frames are transmitted, based on identification information included in the received asynchronous data frames, and transmitting the received synchronous data frames to the determined FCSL.

According to a further exemplary embodiment of the present invention, there is provided a method for receiving multi-protocol data frames, comprising receiving isochronous data frames, determining the upper protocol layer to which the received isochronous data frames are transmitted, to be a stream index of the received isochronous data frames, and transmitting the received isochronous data frames to the determined FCSL. The stream index may be determined when a piconet coordinator (PNC) allows a CTA of a receiving apparatus. The method may further comprise sending a probe request to a transmitting apparatus when it is allotted a CTA to transmit the isochronous data frames and receiving a probe response by the transmitting apparatus in response to the probe request, with the stream index and the mapping information of the FCSL to which the isochronous data frames are transmitted.

According still another exemplary embodiment of the present invention, there is provided an apparatus for receiving multi-protocol data frames, comprising a plurality of frame convergence sub-layer(FCSL) modules supporting the protocols, and a FCLS logic link control(LLC) module receiving data frames transmitted to a wireless transmitting medium through a MAC module and determining a FCSL module to which the data frames are transmitted, based on identification information included in the data frames, and transmitting the data frames to the determined FCSL module. The MAC module may be in conformity with IEEE 802.15.3 standards. The data frames may comprise asynchronous data frames, and the FCSL LLC module may comprise an asynchronous service access point (SAP) detach module detaching the identification information included from the asynchronous data frames so as to determine whether they correspond to the FSCL to which the asynchronous data frames are to be transmitted. The data frames may comprise isochronous data frames, and the FCSL LLC module may comprise a stream index storage module storing therein mapping informing between the FCSL and the stream index, the FCSL to which the isochronous data frames are to be transmitted. A FCSL LLC module may further comprise a probe request/response module allowing the stream index storage module receiving a probe request including mapping information between the stream index and the FCSL and storing therein the mapping information.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is a block diagram illustrating a FCSL (frame convergence sub-layer) model in which avariety of protocols are used;

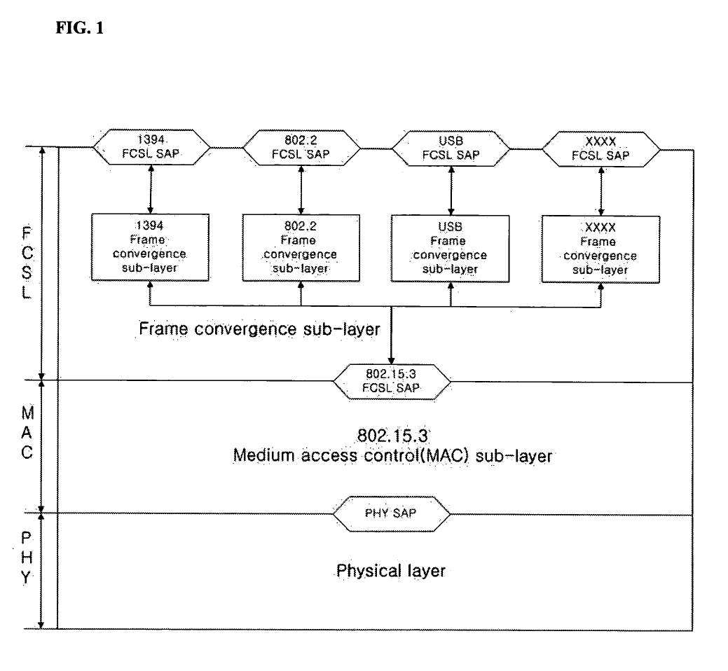

FIG. 2 shows a structure of a protocol stack according to an exemplary embodiment of the present invention;

FIG. 3 shows a structure of a FCSL logic link control of FIG. 2;

FIG. 4 illustrates an example of a CTA (channel time allocation) mapping relationship between two devices; and

FIG. 5 shows a superframe structure for use in the embodiment shown in FIG. 4.

### DETAILED DESCRIPTION OF THE INVENTION

Hereinafter, exemplary embodiments of the present invention will be described in detail with reference to the accompanying drawings, wherein like numerals are used to refer to like elements having the same functions.

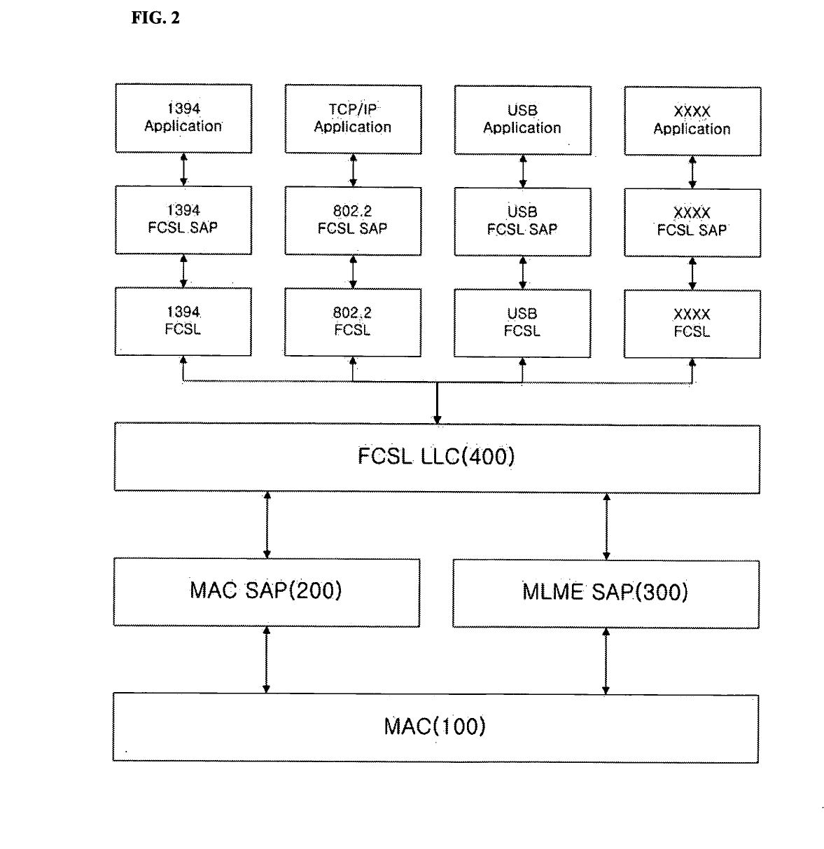

FIG. 2 shows a structure of a protocol stack according to an exemplary embodiment of the present invention.

Referring to FIG. 2, there is shown the protocol stack under the circumstances that applications using the IEEE 1394 protocol, TCP/IP protocol, USB protocol and other protocols (hereinafter, referred to as the “XXXX protocol”) are present in an upper layer.

The protocol stack is configured in such a manner that a MAC layer 100 is located on a physical layer (not shown), a frame convergence sub-layer logic link control (FCSL LLC) 400 is located on the MAC layer 100, and a MAC SAP 200 and a MAC layer management entity (MLME) SAP 300, which serve as an interface, are interposed between the layer 100 and the FCSL LLC 400. FCSLs for a variety of different protocols may be located above the FCSL LLC 400. For example, there may be a 1394 FCSL for an IEEE 1394 packet, an 802.2 FCSL for an IEEE 802.2 packet, a USB FCSL for an USB packet, and a XXXX FCSL for other packets.

A FCSL PDU classification process is implemented to allow each FCSL PDU to be mapped into a specific stream index. Each stream index is associated with a set of quality of service (QoS) characteristics. Upon completion of classification, each FCSL PDU is delivered using QoS parameters specified for the stream index. The classification process uses one or more sets of classification parameters to analyze frames entering the respective FCSLs. For example, the classification parameters set for the 802.2 FCSL comprise classification priority, stream indexes, and protocol-specific parameters such as destination address, source address or priority parameters. For example, the 802.2 FCSL receives an 802.2 frame PDU through the 802.2 FCSL SAP, and then classifies the received PDU according to the destination address, source address and priority parameters. The received PDU is mapped into the specific stream index according to the 802.2 FCSL classification rules, and the received PDU source and destination addresses are mapped into 802.15.3 source ID (ScrID) and destination ID (DestID). Then, a valid frame is delivered to the MAC SAP 200. Furthermore, the 802.2 FCSL receives a frame from the MAC SAP 200 and transfers the received frame to the upper layer through the 802.2 FCSL SAP.

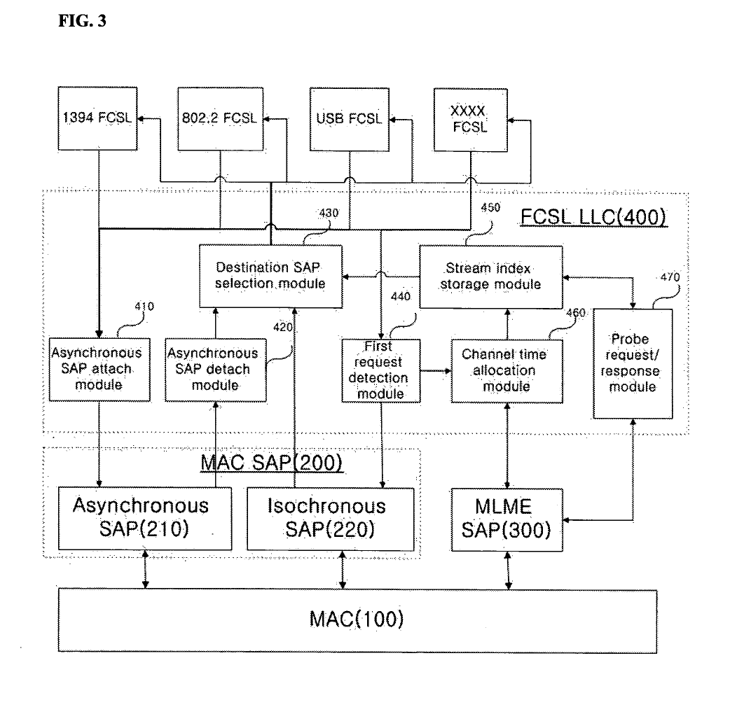

Meanwhile, when only one upper protocol such as the 802.2 protocol is used, the 802.2 FCSL may transfer and receive frames directly to and from the MAC SAP 200 as explained above. However, when another protocol, e.g. a 1394 protocol or a USB protocol, is also used together with the 802.2 protocol, it should be determined through which FCSL the frames pass. Therefore, the present invention is configured to implement a new layer, i.e. the FCSL LLC 400, between the specific FCSL and the MAC SAP 200 so that it can be determined which one of various different protocols is used. The structure of the FCSL LLC 400 will be described in detail with reference to FIG. 3.

The MAC layer 100 is located between the physical layer (not shown) and the MAC SAP 200. The MAC layer 100 refers to beacon information received from a PNC so that the frames from the upper layer are transferred to a wireless medium through the physical layer at an appropriate time. Meanwhile, there is also another interface, i.e. the MLME SAP 300, between the FCSL LLC 400 and the MAC layer 100, in addition to the MAC SAP 200. The MLME SAP 300 is a SAP used for a MLME (not shown). The MLME is used, for example, to reset the MAC layer, perform scanning to determine whether there is any piconet associated with the communication channels, create a new piconet, perform synchronization for a preliminary step for devices associated with a specific piconet, associate devices with a piconet, and/or support a handover mechanism between piconets.

FIG. 3 more specifically illustrates the structure of the FCSL LLC shown in FIG. 2.

The IEEE 802.15.3 MAC supports two kinds of data, i.e. asynchronous data and isochronous data. Referring to FIG. 3, the MAC SAP 200 comprises SAPs for use in the two kinds of data supported by IEEE 802.15.3, i.e. an asynchronous SAP 210 for asynchronous data and an isochronous SAP 220 for isochronous data.

The MLME SAP 300 is a SAP for the MLME and provides a variety of services for managing the MAC layer 100.

The FCSL LLC 400 for allowing a variety of different protocols to be used comprises an asynchronous SAP attach module 410, an asynchronous SAP detach module 420, a destination SAP selection module 430, a first request detection module 440, a channel time allocation module 460, a probe request/response module 470, and a stream index storage module 450.

The asynchronous SAP attach module 410 attaches to a frame an SAP for indicating which specific FCSL the frame is received from, and then delivers the resultant frame to the asynchronous SAP 210. Further, the asynchronous SAP detach module 420 separates the SAP from the frame received from the asynchronous SAP 210 and then delivers the separated SAP to the destination SAP selection module 430. The destination SAP selection module 430 determines which FCSL has forwarded the frame based on the SAP separated from the detach module 420, and then sends the frame to the determined FCSL.

The first request detection module 440 requests channel time allocation (CTA) from the channel time allocation module 460 when receiving an isochronous data transfer request from the specific FCSL. The channel time allocation module 460 is allocated a channel through the MLME SAP 300 from the PNC (not shown). This means receiving a valid stream index. The received stream index, a destination SAP thereof and a device ID are stored in the stream index storage module 450. The destination SAP has a different value for each FCSL. When the CTA is made, the PNC broadcasts CTA information to all devices through a beacon. Meanwhile, a destination device receives the beacon and sends a probe request to a source device through the probe request/response module 470. At this time, in an exemplary embodiment, the requested information element (IE) may be one such as a piconet service IE or a vendor specific IE which is not defined by the IEEE 802.15.3 standards. In response to the probe request, the probe request/response module 470 in the source device creates IE based on content stored in the stream index storage module 450 and sends a probe response to the destination device. The destination device receives the probe response and stores the IE forwarded by the source device in its own stream index storage module 450.

Meanwhile, the destination SAP selection module 430 in the destination device selects a destination FCSL by referring to the information stored in the stream index storage module 450 on the basis of the stream index and an Originator ID (OriglID) in the frame input through the isochronous SAP 220.

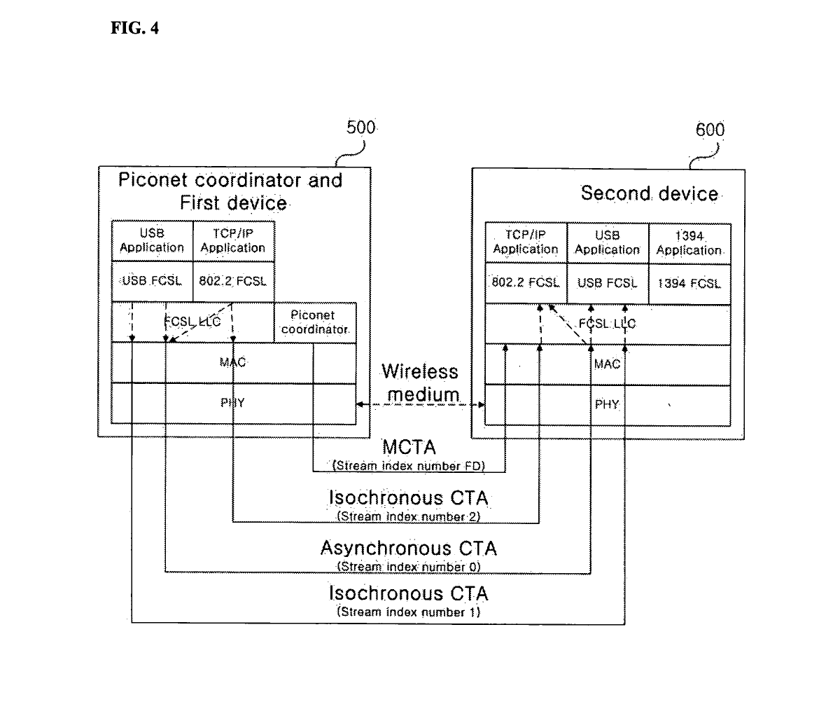

FIG. 4 illustrates an example of a CTA mapping relationship between two devices.

Referring to FIG. 4, a first device 500 is a source device operable to transfer data to a second device 600. The first device 500 can transfer and receive data in USB protocol and TCP/IP protocol, while the second device 600 can transfer and receive data in TCP/IP protocol, USB protocol, and 1394 protocol. The first device 500 may transfer asynchronous and isochronous data in USP protocol and TCP/IP protocol to the second device 600. Furthermore, in this embodiment, the first device 500 is implemented in such a manner as to function as a PNC, but a separate PNC may also be employed.

First, the transfer of asynchronous data will be described. It is assumed that the asynchronous data in USB protocol is transferred. In the first device 500, USB PDUs are transferred to the USB FCSL through the USB FCSL SAP (not shown). In the FCSL, the transferred PDUs are translated into a frame compatible with the IEEE 15.3 MAC layer 100. Then, the frame is delivered to the asynchronous SAP attach module 410. The asynchronous SAP attach module 410 attaches SAP information to the frame so that the second device 600 can recognize that the data are transferred through the USB FCSL, and send the frame to the asynchronous SAP 210. That is, the asynchronous SAP attach module 410 attaches an indication that the frame is transferred through the USB FCSL SAP to the relevant frame. The frame passed through the asynchronous SAP attach module 410 is delivered to the asynchronous SAP module 210 and then sent to the MAC layer 100. The frame is also transferred to the second device 600 through the wireless transfer media after passing through the MAC layer 100 and the physical layer (not shown).

In the second device 600 where the frame sent by the first device is received, the asynchronous data are transferred to the asynchronous SAP module 210 via the physical layer and the MAC layer 100. The SAP information is separated in the asynchronous SAP detach module 420. The destination SAP selection module 430 determines that the frame should be transferred to the USB FCSL based on the SAP information, and delivers the frame to the USB FCSL. Then, the frame is sent to the USB FCSL SAP (not shown) and finally to the USB application. It should be noted that the asynchronous data can be transferred with the CTA allocated by the PNC, and the asynchronous data may be alternatively transferred based on a contention access period (CAP) or some management CTA (MCTA). Meanwhile, according to the aforementioned procedures, the data in TCP/IP protocol can also be transferred together with the asynchronous data in USB protocol. In this case, since only one asynchronous CTA for the asynchronous data between two devices can be used, the USB and 802.2 PDUs share the asynchronous CTA. The index number of the asynchronous CTA always has a fixed value of “zero”.

Next, the transfer of isochronous data will be described.

It is assumed that USB application data is to be transferred. First, if an isochronous data transfer request is issued from the USB FCSL in the first device 500, the first request detection module 440 determines whether this request is a first transfer request. If so, the first request detection module 440 requests the channel time allocation module 460 for CTA. The channel time allocation module 460 requests the CTA through the MLME SAP 300, and receives a valid stream index through the MLME SAP 300 when being allocated the channel time. The CTA is determined by the PNC. For example, assuming that the first device 500 receives the channel index of “1”, the stream index storage module 450 stores the allocated stream index (i.e., “1”), a destination SAP value for the allocated stream index, and a device ID. The destination SAP is defined to have a unique value for each FCSL. Once the CTA is made, the PNC broadcasts the CTA information to all devices through the beacon. The second device 600, which has received the beacon, requests the first device 500 for a probe response. Then, the first device 500 creates the IE on the basis of the channel index, destination SAP value and device ID, and responds to the second device 600. The second device 600 receives the probe response from the first device 500 and stores the channel index, destination SAP value and device ID. Thereafter, the data in USB protocol are sent to the MAC layer 100, via the USB FCSL and isochronous SAP 220 in the first device 500, and then to the wireless medium.

The second device 600 receives the frame forwarded by the first device 500. The received frame is transferred to the USB application via the MAC layer 100, the isochronous SAP 200, the destination SAP selection module 430 and the USB FCSL.

Furthermore, the isochronous data in TCP/IP protocol can also be transferred in the same manner as described above. In FIG. 4, however, the index number “2” is given, which is different from the stream index given to the USB application data.

In the IEEE 802.15.3 MAC layer, a value of “0xFD” is reserved for the stream index for MCTA. Further, a value of “0xFE” is reserved for an unspecified stream.

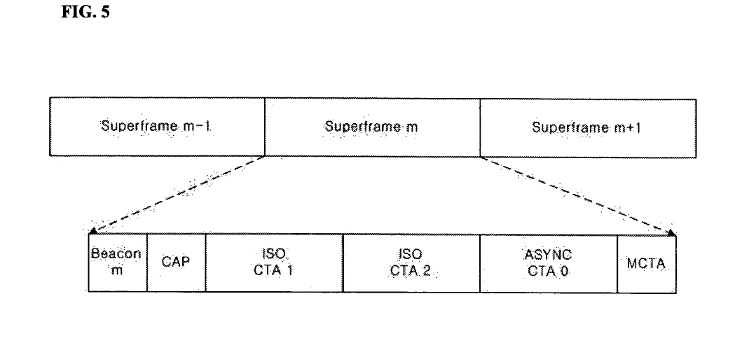

FIG. 5 shows a superframe structure for use in the embodiment shown in FIG. 4.

The superframe is a frame between beacons and may comprise a beacon, a contention access period (CAP), an asynchronous CTA, isochronous CTAs, and MCTA. Referring to FIG. 4, the stream indexes of the asynchronous data, USB data and TCP/IP data have the values of “0”, “1”, and “2”, respectively. Thus, the superframe has ISO CTA 1 containing USB data, ISO CTA 2 containing TCP/IP data, and ASYNC CTA 0 containing the USB and TCP/IP data.

According to the present invention so constructed, there is an advantage in that even though a variety of different FCSLs are simultaneously in operation, a specific FCSL associated with data supplied from a MAC layer can be easily located without confusion.

It will be understood by those skilled in the art that various modifications and changes may be made within the technical spirit or scope of the invention. For example, although the aforementioned embodiments are shown and described based on IEEE 802.15.3, the present invention is not limited thereto and is also applicable to the other cases where frame convergence sub-layers for a plurality of protocols are present. Further, while it has been described in the embodiment that the asynchronous and isochronous data are transferred, the present invention is also not limited thereto. Data in other formats, for example, may be transferred, which is also included within the technical scope of the present invention. Furthermore, while it has been described in the embodiment that the asynchronous SAP attach module and asynchronous SAP detach module are individually and separately provided, the present invention is also not limited thereto. Both modules may be incorporated into a single module, which also falls within the technical scope of the present invention.

Accordingly, it should be understood that the exemplary embodiments of the present invention described herein are not restrictive but illustrative. It should be construed that various changes and modifications derived from the spirit and scope of the appended claims and equivalents thereof may fall within the spirit and scope of the invention.

What is claimed is:

1. A method for transmitting multi-protocol data frames through a predetermined MAC, comprising:
(a) receiving data frames transmitted from an upper protocol layer;
(b) providing the received data frames with identification information on the upper protocol layer having transmitted the data frame; and
(c) transmitting the data frames including identification information.

2. The method as claimed in claim 1, wherein the data frames are transmitted in the mode of MAC based on IEEE 802.15.3 standards.

3. The method as claimed in claim 2, wherein the data frames are transferred in either mode of an asynchronous or isochronous transfer.

4. A method for transmitting multi-protocol asynchronous data through a predetermined MAC, comprising:
(a) receiving asynchronous data frames from an upper protocol layer;
(b) providing the received asynchronous data frames with identification information on the upper protocol layer having transmitted the asynchronous data frame; and
(c) transmitting the asynchronous data frames including identification information.

5. An apparatus for transmitting multi-protocol isochronous data through a predetermined MAC, comprising:
(a) receiving isochronous data frames from an upper protocol layer;
(b) providing the received isochronous data frames with a stream index mapped into a frame convergence sub layer (FCSL); and
(c) transmitting the isochronous data frames during a channel time allocation (CTA) of the provided stream index.

6. The method as claimed in claim 5, wherein the stream index mapped into a FCSL having transmitted the isochronous data is obtained with the CTA from a piconet coordinator (PNC).

7. The method as claimed in claim 6, further comprising sending a probe response with the stream index mapping information when having received a probe request from a receiving apparatus after receipt of the CTA.

8. An apparatus for transmitting multi-protocol data frames, comprising:
a plurality of frame convergence sub-layer (FCSL) modules supporting different protocols;
a FCSL logic link control(LLC) module receiving data frames from at least one module among the FCSL modules and providing the data frames to identification information so as to allow a receiving apparatus to identify the FCSL having transmitted the data frames; and
a medium access control (MAC) module receiving data frames from the FCSL LLC module and transmitting the data frames to a wireless transmitting medium.

9. The apparatus as claimed in claim 8, wherein the MAC module is based on IEEE 802.15.3 standards.

10. The apparatus as claimed in claim 8, wherein the received data frames comprise asynchronous data frames, the FCSL LLC module comprises an asynchronous service access point (SAP) attach module providing the asynchronous data frames with identification information so as to allow the receiving apparatus to identify the FCSL having transmitted the asynchronous data frames.

11. The apparatus as claimed in claim 8, wherein the data frames received from the FCSL module comprise isochronous data frames, and the FCSL LLC module comprises a stream index storage module storing therein a stream index for the FCSL having transmitted the isochronous data frames, and the MAC module transmits the isochronous data frames during allocation of the CTA to have the stored stream index.

12. The apparatus as claimed in claim 11, wherein the FCSL LLC module further comprises a probe request/response module which responds to a probe request from the receiving apparatus, with the stream index for the FCSL having transmitted the isochronous data frames, stored in the stream index storage module.

13. A method for receiving multi-protocol data frames, comprising:
receiving data frames;
determining an upper protocol layer to which the received data frames are transmitted, based on identification information included in the received data frames; and
transmitting the received data frames to the determined upper protocol layer.

14. The method as claimed in claim 13, wherein the received data frames comprise data frames in the MAC mode based on IEEE 802.15.3 standards.

15. The method as claimed in claim 14, wherein the received data frames are transferred in either mode of an asynchronous or isochronous transfer.

16. A method for receiving multi-protocol data frames, comprising:
receiving asynchronous data frames;
determining an upper protocol layer to which the received asynchronous data frames are transmitted, based on identification information included in the received asynchronous data frames; and
transmitting the received synchronous data frames to the determined FCSL.

17. A method for receiving multi-protocol data frames, comprising:
receiving isochronous data frames;
determining the upper protocol layer to which the received isochronous data frames are transmitted, to be a stream index of the received isochronous data frames; and
transmitting the received isochronous data frames to the determined upper protocol layer.

18. The method as claimed in claim 17, wherein the stream index is determined when a piconet coordinator (PNC) allows a CTA of a receiving apparatus.

19. The method as claimed in claim 18, further comprising sending a probe request to a transmitting apparatus when it is allotted a CTA to transmit the isochronous data frames and receiving a probe response by the transmitting apparatus in response to the probe request, with the stream index and the mapping information of the FCSL to which the isochronous data frames are transmitted.

20. An apparatus for receiving multi-protocol data frames, comprising:
a plurality of frame convergence sub-layer (FCSL) modules supporting the protocols; and
a FCLS logic link control (LLC) module receiving data frames transmitted to a wireless transmitting medium through a MAC module and determining a FCSL module to which the data frames are transmitted, based on identification information included in the data frames, and transmitting the data frames to the determined FCSL module.

21. The apparatus as claimed in claim 20, wherein the MAC module is based on IEEE 802.15.3 standards.

22. The apparatus as claimed in claim 20, wherein the data frames comprise asynchronous data frames, and the FCSL LLC module comprises an asynchronous service access point (SAP) detach module detaching the identification information included from the asynchronous data frames so as to determine whether they correspond to the FSCL to which the asynchronous data frames are to be transmitted.

23. The apparatus as claimed in claim 20, wherein the data frames comprise isochronous data frames, and the FCSL LLC module comprises a stream index storage module storing therein mapping informing between the FCSL and the stream index, the FCSL to which the isochronous data frames are to be transmitted.

24. The apparatus as claimed in claim 20, wherein the FCSL LLC module further comprises a probe request/response module allowing the stream index storage module receiving a probe request including mapping information between the stream index and the FCSL and storing therein the mapping information.
